(19) United States
(12) Patent Application Publication
(10) Pub. No.: US 2006/0017863 A1
(43) Pub. Date: Jan. 26, 2006

(54) Liquid crystal display apparatus

(75) Inventor: Hak-yong Kim, Gwacheon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/187,000

(22) Filed: Jul. 22, 2005

(30) Foreign Application Priority Data
Jul. 22, 2004 (KR) 2004-0057040

(51) Int. Cl. G02F 1/1335

(52) U.S. Cl. 349/62

(57) ABSTRACT

An LCD apparatus including an LCD panel displaying a picture thereon; an optical sheet provided at a rear of the LCD panel; a surface light source spacedly provided at a rear of the optical sheet and emitting light to the optical sheet. A supporter is provided between the optical sheet and the surface light source to support the optical sheet and the surface light source. Thus the present invention provides an LCD apparatus having an improved structure of stably supporting a surface light source and an optical sheet.

### CROSS-REFERENCE TO RELATED APPLICATIONS

This application claims the benefit of Korean Patent Application No. 2004-0057040, filed on Jul. 22, 2004, in the Korean Intellectual Property Office, the disclosure of which is incorporated herein by reference.

### BACKGROUND OF THE INVENTION

1. Field of the Invention

Apparatuses consistent with the present invention relate to a liquid crystal display (LCD) apparatus, and more particularly, to an LCD apparatus having an improved structure in which a supporter is provided between a surface light source and an optical sheet.

2. Description of the Related Art

Generally, an LCD apparatus comprises an LCD panel displaying a picture thereon, an optical sheet provided in a rear of the LCD panel, and a backlight unit illuminating the optical sheet and the LCD panel.

The backlight unit is classified into a direct type and an edge type according to its dispositions. In the case of the direct type, a light source is disposed under the optical sheet and directly emits light to the optical sheet and the LCD panel. In the case of the edge type, the light source is disposed at the edges of a light guide plate and emits light to the optical sheet and the LCD panel via the light guide plate.

Hereinbelow, the direct type LCD apparatus comprising a surface light source disposed under the optical sheet and emitting light toward the LCD panel will be described.

FIG. 1 is a schematic section view of a conventional LCD apparatus comprising the surface light source.

As shown therein, a conventional LCD apparatus 101 comprises an LCD panel 105; a plurality of optical sheets 110 provided in a rear of the LCD panel 105 and enhancing concentration efficiency of incident light on the LCD panel 105; a surface light source 120 disposed under and spaced from the optical sheets and emitting light to the LCD panel 105; and a mold frame 107 supporting the LCD panel 105, the surface light source 120, etc. The surface light source 120 comprises a plurality of lamps 121 disposed at the same intervals in a rear of the optical sheets 110, and a substrate 125 provided in a rear of the lamps 121.

The surface light source 120 is disposed in the rear of the optical sheets 110 and directly emits light to the optical sheets 110, so that the light concentration efficiency of the surface light source 120 is enhanced as compared with that of the edge type LCD apparatus, thereby realizing high brightness. Thus, because the size of LCD apparatuses is on the rise, the surface light source 120 is widely used in the larger sized LCD apparatuses.

The plurality of lamps 121 are disposed on the substrate 125 and spaced not only from each other but also from the optical sheets 110. However, in the conventional LCD apparatus, the surface light source and the optical sheet are spaced from each other, and thus it is difficult to keep a distance between the surface light source and the optical sheet uniformly when they are assembled into the LCD apparatus. Further, the larger the size of the LCD apparatus, the weaker the relative strength of the surface light source and the optical sheet. In this case, the surface light source and the optical sheet need to be stably supported.

### SUMMARY OF THE INVENTION

Accordingly, it is an exemplary aspect of the present invention to provide an LCD apparatus having an improved structure which stably supports a surface light source and an optical sheet.

The foregoing and/or other aspects of the present invention are also achieved in an exemplary embodiment by providing an LCD apparatus comprising: an LCD panel displaying a picture thereon; an optical sheet provided in a rear of the LCD panel; a surface light source spacedly provided in a rear of the optical sheet and emitting light to the optical sheet; and a supporter provided between the optical sheet and the surface light source and supporting the optical sheet and the surface light source.

According to an exemplary aspect of the invention, the surface light source comprises an upper plate formed with a plurality of protruding portions protruding toward the rear of the optical sheets, and a lower plate coupled to the upper plate and forming a discharging space between the protruding portion and the lower plate.

According to an exemplary aspect of the invention, the supporter comprises a plurality of accommodating portions to accommodate the respective protruding portions, and a plurality of surface light source supporting portions formed between the respective accommodating portions and contacting the upper plate between the respective protruding portions.

According to an exemplary aspect of the invention, the surface light source is attached to the upper plate between the respective protruding portions.

According to an exemplary aspect of the invention, the surface light source comprises a plurality of lamps spaced from each other, and a plate provided in a rear of the respective lamps, and the supporter comprises a plurality of accommodating portions to accommodate the respective lamps, and a plurality of surface light source supporting portions formed between the respective accommodating portions and contacting the plate between the respective lamps.

According to an exemplary aspect of the invention, the surface light source supporting portion is attached to the plate between the respective protruding portions.

According to an exemplary aspect of the invention, the supporter uniformizes the light emitted from the surface light source to the optical sheet.

According to an exemplary aspect of the invention, the supporter includes PMMA material.

### BRIEF DESCRIPTION OF THE DRAWINGS

The above and/or other aspects and advantages of the present invention will become apparent and more readily appreciated from the following description of the illustrative embodiments, taken in conjunction with the accompany drawings of which:

FIG. 1 is a schematic section view of a conventional LCD apparatus;

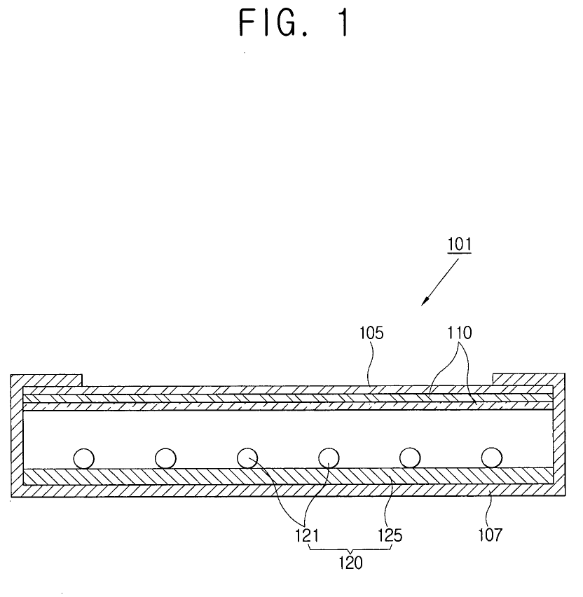

FIG. 2 is a schematic section view of an LCD apparatus according to a first exemplary embodiment of the present invention;

FIG. 3 is a partially enlarged perspective view of the LCD apparatus of FIG. 2;

FIG. 4 is a schematic section view of an LCD apparatus according to a second exemplary embodiment of the present invention; and

FIG. 5 is a partially enlarged perspective view of the LCD apparatus of FIG. 4.

### DETAILED DESCRIPTION OF EXEMPLARY, NON-LIMITING EMBODIMENTS

Reference will now be made in detail to embodiments of the present invention, examples of which are illustrated in the accompanying drawings, wherein like reference numerals refer to like elements throughout. The embodiments are described below in order to explain the present invention by referring to the figures.

### First Exemplary Embodiment

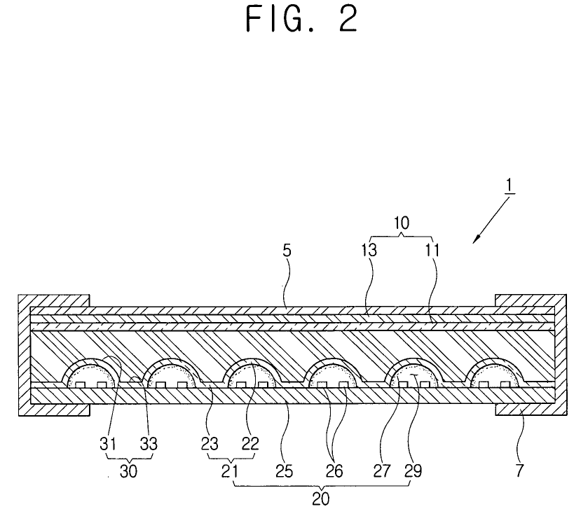

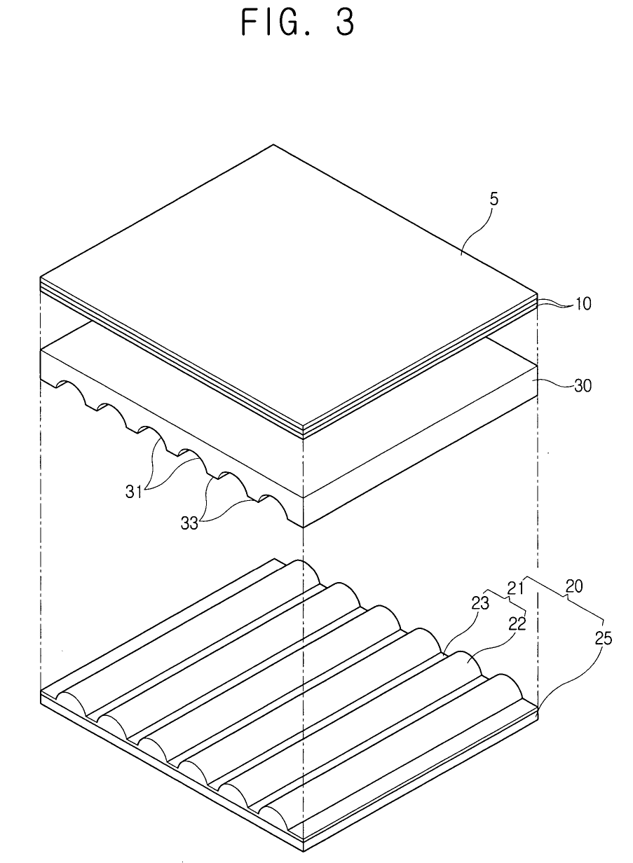

As shown in FIGS. 2 and 3, an LCD apparatus 1 according to an embodiment of the present invention comprises an LCD panel 5 displaying a picture thereon; an optical sheet 10 disposed at a rear of the LCD panel 5; a surface light source 20 spacedly disposed from a rear of the optical sheet 10 and emitting light to the LCD panel 5; a frame 7 provided outside of both the LCD panel 5 and the surface light source 20 and supporting the LCD panel 5 and the surface light source 20; and a supporter 30 provided between the optical sheet 10 and the surface light source 20 and supporting the optical sheet 10 and the surface light source 20.

The LCD panel 5 comprises a pair of substrates (not shown) and a liquid crystal (not shown) sandwiched between the substrates. When voltage is applied between the pair of substrates filled with the liquid crystal, the molecular arrangement of the liquid crystal is changed and thus the transmissivity of the light emitting from the surface light source 20 is adjusted, thereby displaying a picture.

The optical sheet 10 comprises a plurality of sheets to enhance concentration efficiency of the light emitted from the surface light source 20 to the LCD panel 5. That is, the optical sheets 10 comprise a plurality of diffusion sheets 11 to diffuse and uniformize the light emitted from the surface light source 20; a prism sheet 13 to change a traveling path of the light diffused by the diffusion sheet 11 at a predetermined angle; etc.

The frame 7 is provided outside of the LCD panel 5, the optical sheets 10, and the surface light source 20, and supports the LCD panel 5, the optical sheets 10, the surface light source 20, etc.

The surface light source 20 is spaced from the rear of the optical sheet 10, and comprises an upper plate 21 formed with a plurality of protruding portions 22 spaced from each other, and a lower plate 25 coupled to the upper plate 21 to form a discharging space 29 between the protruding portion 22 and the lower plate 25. Further, the surface light source 20 comprises a fluorescent layer 27 coated on an inner wall of the protruding portion 22 forming the discharging space 29, and electrodes 26 to make a discharge in the discharging space 29.

The discharging space 29 is filled with inert gas such as mercury (Hg) gas, argon (Ar) gas, or the like. The inert gas filled in the discharging space 29 is discharged when voltage is applied between the electrodes 26, thereby generating ultraviolet rays.

The fluorescent layer 27 is preferably coated on the inner wall of the protruding portion 22, but may be coated on the lower plate 25. The fluorescent layer 27 absorbs the ultraviolet rays generated by the voltage applied between the electrodes 26 and then transforms the ultraviolet rays into visible rays.

The electrodes 26 are preferably provided in the lower plate 25, but may be provided in the upper plate 21. The electrodes 26 make plasma discharge in the discharging space 29 when voltage is applied therebetween, and thus the ultraviolet rays due to the plasma discharge excites the fluorescent layer 27 to generate the visible rays, thereby emitting light.

The upper plate 21 is made of glass material, so that the light can travel from the discharging space 29 toward the optical sheet 10 through the upper plate 21. Alternatively, the upper plate 21 may be made of various materials such as plastics as long as the light can travel from the discharging space 29 toward the optical sheet 10 through the upper plate 21. Further, the upper plate 21 is formed with a contact-supporting portion 23 formed between the protruding portions 22 in order to contact a surface light source supporting portion 33 of the supporter 30 (to be described later).

The protruding portions 22 are spaced from each other, and each of them is longitudinally formed in the upper plate 21 and has a semi-elliptical section. Alternatively, the protruding portion 22 may have a semicircular section, a rectangular section, a triangular section, or the like.

The contact-supporting portion 23 is formed between the protruding portions 22, and has a bottom surface contact-coupled to an upper surface of the lower plate 25 and a top surface contact-coupled to the surface light source supporting portion 33 of the supporter 30. Here, the bottom and top surfaces of the contact-supporting portion 23 are coupled to the lower plate 25 and the surface light source supporting portion 33 by an adhesive, respectively, but may be coupled by a double sided tape, a screw, a bolt or the like.

The lower plate 25 is coupled to the upper plate 21 so as to form the discharging space 29. The lower plate 25 is preferably, but not necessarily, made of a flat glass plate. Alternatively, the lower plate 25 may be made of various materials such as a flat plastic plate. Further, the lower plate 25 can be provided with a reflecting sheet (not shown) to reflect the light generated in the discharging space 29 toward the optical sheet 10.

The supporter 30 comprises a plurality of accommodating portions 31 to accommodate the plurality of protruding portion 22, and the surface light source supporting portions 33 formed between the respective accommodating portions 31 and contacting the upper plate 21 between the respective accommodating portions 31. The supporter 30 uniformizes the light emitted from the surface light source 20 to the optical sheet 10. The supporter 30 is made of PMMA (polymethylmethacrylate) material or the like, which is excellent in diffusion and transmissivity of the light, so that the supporter 30 can function as a light guide plate. A top surface of the supporter 30 is flat in correspondence to the shape of the optical sheet 10. Further, the top surface of the supporter 30 can contact and support the optical sheet 10 so as to prevent the optical sheet 10 from bending toward the surface light source 10.

The accommodating portion 31 is shaped corresponding to the shape of the protruding portion 22 and accommodates the protruding portion 22. Here, the accommodating portion 31 can be spaced from the protruding portion 22 or contact the protruding portion 22 when it accommodates the protruding portion 22. The accommodating portion 31 can have a semi-elliptical section corresponding to the shape of the protruding portion 22. Alternatively, the accommodating portion 31 may have various sections such as a semicircular section, a rectangular section, or the like as long as it can accommodate the protruding portion 22.

The surface light source supporting portion 33 is attached to the upper plated 21 between the respective protruding portions 22. That is, the surface light source supporting portion 33 is formed between the respective accommodating portions 31 and attached to the contact-supporting portion 23 of the upper plate 21, thereby allowing the supporter 30 to support the surface light source 20. At this time, the surface light source supporting portion 33 is attached to the contact-supporting portion 23 by an adhesive or the like.

With this configuration, a process of assembling the LCD apparatus 1 according to the first embodiment of the present invention is as follows.

First, there are provided the surface light source 20 formed with the plurality of protruding portions 22, and the supporter 30 formed with the plurality of accommodating portions 31 to accommodate the respective protruding portion 22. Then, the supporter 30 is put on the surface light source 20. That is, the protruding portion 22 of the surface light source 20 is accommodated in the accommodating portion 31 of the supporter 30, and the surface light source supporting portion 33 of the supporter 30 is in contact with the contact-supporting portion 23 of the surface light source 20. At this time, the adhesive is applied between the surface light source supporting portion 33 and the contact-supporting portion 23, so that the surface light source supporting portion 33 and the contact-supporting portion 23 are attached, thereby coupling the supporter 30 with the surface light source 20. Thereafter, the plurality of optical sheets 10 and the LCD panel 5 are put on the supporter 30, and then the frame 7 is coupled to them.

With this configuration, the LCD apparatus 1 according to the first embodiment of the present invention comprises the supporter 30 provided between the optical sheet 10 and the surface light source 20 and supporting the optical sheet 10 and the surface light source 20, thereby keeping a distance between the surface light source 20 and the optical sheet 10 uniformly when they are assembled into the LCD apparatus 1. Particularly, in the case where the area of the surface light source 20 and the optical sheet 10 is large relatively to the thickness thereof, due to the size of LCD apparatuses being on the rise, the supporter stably supports the surface light source 20 and the optical sheet 10 to prevent the strength of the surface light source 20 and the optical sheet 10 from becoming weaker. Further, the supporter 30 uniformizes the light emitted from the surface light source 20 to the optical sheet 10, thereby functioning as a light guide plate.

### Second Embodiment

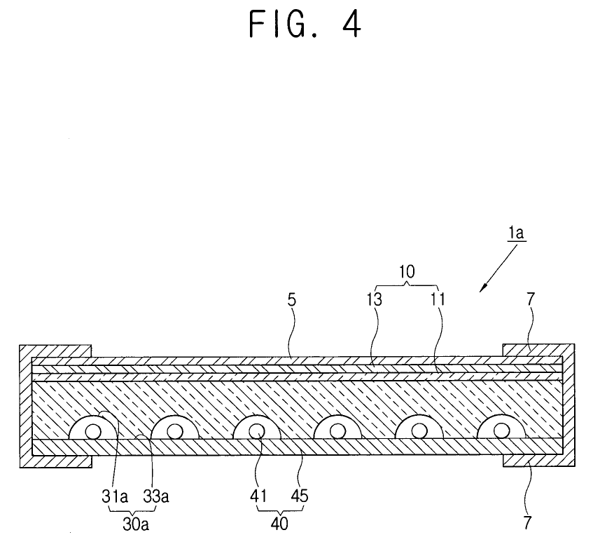

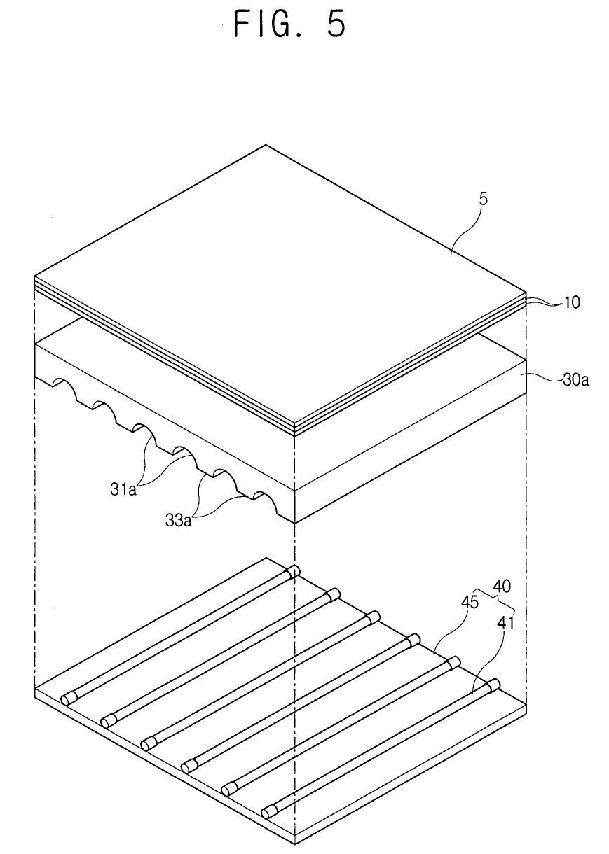

FIGS. 4 and 5 are respectively a schematic section view and an exploded perspective view of an LCD apparatus according to a second embodiment of the present invention. Contrary to the first embodiment, an LCD apparatus 1a according to the second embodiment of the present invention comprises a surface light source 40 provided with a plurality of lamps 41, and a supporter 30a formed with a plurality of accommodating portions 31a to accommodate the plurality of lamps 41.

The surface light source 40 comprises the plurality of lamps 41 arranged to be spaced from each other, and a plate 45 provided at a rear of the plurality of lamps 41. The lamp 41 has a circular section and is longitudinally shaped like a bar. The plate 45 is flat, and may function as a reflecting sheet to reflect the light emitted from the lamp 41 toward the optical sheet 10.

The supporter 30a comprises the plurality of accommodating portions 31a to accommodate the respective lamps 41, and a surface light source supporting portion 33a formed between the accommodating portions 31a to contact the plate 45 between the lamps 41. The supporter 30a uniformizes the light emitted from the surface light source 40 to the optical sheet 10. That is, the supporter 30a is made of PMMA (polymethylmethacrylate) material or the like, for example, thereby functioning as a light guide plate.

The accommodating portion 31a is recessed on the bottom surface of the supporter 30a in order to accommodate each of the lamps 41. Alternatively, the accommodating portion 31a may accommodate each pair of lamps 41 and may accommodate three or more lamps 41.

The surface light source supporting portion 33 is attached to the plate 45 between the respective lamps 41. The surface light source supporting portion 33 is preferably attached to the plate 45 by an adhesive, but may be attached by a double sided tape, a screw, or the like.

With this configuration, the LCD apparatus according to the second embodiment of the present invention comprises the supporter provided between the optical sheet and the surface light source and supporting the optical sheet and the surface light source, thereby keeping a distance between the surface light source and the optical sheet constant when they are assembled into the LCD apparatus. Particularly, in the case where the area of the surface light source and the optical sheet is large relative to the thickness thereof, due to the size of LCD apparatuses being on the rise, the supporter stably supports the surface light source and the optical sheet to prevent the strength of the surface light source and the optical sheet from becoming weaker. Further, the supporter uniformizes the light emitted from the surface light source to the optical sheet, thereby functioning as a light guide plate.

As described above, the present invention provides an LCD apparatus which can be easily assembled and stably support a surface light source and an optical sheet even though the size thereof is increased.

Further, the present invention provides an LCD apparatus in which a supporter uniformizes light emitted from a surface light source to an optical sheet, thereby functioning as a light guide plate.

Although a few exemplary embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. An LCD apparatus comprising:
an LCD panel displaying a picture thereon;
an optical sheet provided behind the LCD panel;
a surface light source provided behind the optical sheet which emits light to the optical sheet; and
a supporter provided between the optical sheet and the surface light source, the supporter supports the optical sheet and the surface light source.

2. The LCD apparatus according to claim 1, wherein the surface light source comprises an upper plate formed with a plurality of protruding portions protruding toward the optical sheets, and a lower plate coupled to the upper plate to provide discharge spaces respectively between the protruding portions and the lower plate.

3. The LCD apparatus according to claim 2, wherein the supporter comprises a plurality of accommodating portions to accommodate the protruding portions respectively, and a plurality of surface light source supporting portions provided between the accommodating portions respectively, the plurality of surface light source supporting portions contact the upper plate between the protruding portions respectively.

4. The LCD apparatus according to claim 3, wherein the lower plate is attached to the upper plate between the protruding portions respectively.

5. The LCD apparatus according to claim 1, wherein the surface light source comprises a plurality of lamps spaced from each other, and a plate provided at a rear of the lamps respectively, and
the supporter comprises a plurality of accommodating portions to accommodate the lamps respectively, and a plurality of surface light source supporting portions formed between the accommodating portions respectively, the plurality of surface light source supporting portions contact the plate between the lamps respectively.

6. The LCD apparatus according to claim 5, wherein the surface light source supporting portions are attached to the plate between the protruding portions respectively.

7. The LCD apparatus according to claim 1, wherein the supporter uniformizes the light emitted from the surface light source to the optical sheet.

8. The LCD apparatus according to claim 7, wherein the supporter includes PMMA material.

9. The LCD apparatus according to claim 2, wherein the supporter uniformizes the light emitted from the surface light source to the optical sheet.

10. The LCD apparatus according to claim 9, wherein the supporter includes PMMA material.

11. The LCD apparatus according to claim 5, wherein the supporter uniformizes the light emitted from the surface light source to the optical sheet.

12. The LCD apparatus according to claim 11, wherein the supporter includes PMMA material.

13. The LCD apparatus according to claim 3, wherein the accommodating portions are concave shaped.

14. The LCD apparatus according to claim 13, wherein the protruding portions are convex shaped.

15. The LCD apparatus according to claim 1, wherein the supporter has a side which contacts the surface light source and has another side which contacts the optical sheet.

16. The LCD apparatus according to claim 1, further including a frame that engages an outer portion of the LCD panel and an outer portion of the surface light source.
